(19) United States
(12) Patent Application Publication
(10) Pub. No.: US 2012/0208045 A1
(43) Pub. Date: Aug. 16, 2012

(54) METHOD OF FABRICATING AMORPHOUS COATINGS ON CRYSTALLINE SUBSTRATES

(75) Inventors: SANDIP P. HARIMKAR, Stillwater, OK (US); ASHISH KUMAR SINGH, Stillwater, OK (US)

(73) Assignee: THE BOARD OF REGENTS FOR OKLAHOMA STATE UNIVERSITY, Stillwater, OK (US)

(21) Appl. No.: 13/370,999

(22) Filed: Feb. 10, 2012

Related U.S. Application Data
(60) Provisional application No. 61/442,078, filed on Feb. 11, 2011.

(51) Int. Cl. B32B 15/01; B32B 15/04; C04B 35/653

(52) U.S. Cl. 428/681; 427/576; 428/457

(57) ABSTRACT

An amorphous coating and method of fabricating the same on a substrate is disclosed. An amorphous iron based powder is located onto an aluminum alloy substrate. Pressure is applied to the powder and substrate at a processing temperature below a crystallization temperature of the powder. The powder and substrate are then spark plasma sintered for infiltrating the substrate material into the powder for resulting in a composite amorphous coating. The powder and substrate are then rapidly heated and held for 15 minutes at the processing temperature. The powder and substrate are then rapidly cooled at a cooling rate of approximately 150° C./minute. In one embodiment, the powder is comprised of Fe₄₈Cr₁₅Mo₁₄Y₂C₁₅B₆ alloy composition.

### CROSS REFERENCE TO RELATED APPLICATIONS

This application claims the priority of U.S. Provisional Patent Application No. 61/442,078 entitled “METHOD OF FABRICATING AMORPHOUS COATINGS ON CRYSTALLINE SUBSTRATES,” filed Feb. 11, 2011, the contents of which are hereby incorporated by reference.

### FIELD OF THE INVENTION

The invention relates to a method of processing amorphous coatings on metallic substrates. More particularly, the invention relates to a method utilizing spark plasma sintering (SPS) to fabricate nano-crystalline and amorphous coatings on metallic substrates.

### BACKGROUND OF THE INVENTION

Amorphous materials or bulk metallic glasses represent a new class of advanced materials exhibiting attractive combinations of properties such high strength/hardness and excellent wear/corrosion resistance. These outstanding properties are primarily due to disordered atomic arrangement in amorphous materials that result in an absence of grain boundaries and an absence of defects in the microstructure. The non-equilibrium nature of amorphous materials offers outstanding properties. However, it also presents significant challenges in the processing of such materials. Even though the rapid solidification, i.e., casting, methods for processing amorphous alloys are well established, the need for simultaneous mold filling and rapid cooling rate limits the range of geometries that can be formed. These processing difficulties in combination with low tensile ductility and toughness are likely to limit the applications of amorphous materials as bulk structural materials. However, the amorphous materials can be good candidates for wear/corrosion resistant coatings on the crystalline substrates.

Significant efforts have been made in the past to fabricate amorphous coatings on crystalline substrates using various processes such as laser surface cladding and high velocity oxy-fuel coating/thermal spraying. Researchers have reported laser cladding of Zr-based amorphous coating on magnesium alloy for structural applications. The laser cladding resulted in the formation of nanocrystalline phases in the amorphous matrix of the coating. Other researchers also observed the formation of crystalline phases in Ni—Cr—B—Si coating laser clad on Al—Si alloy. Still others attempted laser cladding of the Fe-based amorphous coatings on steel substrates and observed formation of intermetallic phases in the coating. While laser surface cladding provides very high cooling rates (up to 10⁶ K/s), most of these approaches have had limited success in retaining fully amorphous structure in the coatings. This can be primarily attributed to the dilution of the melt pool from the underlying substrate partially melted during laser processing. The melt dilution significantly influences the glass forming ability making it difficult to solidify into amorphous structure. Furthermore, the solid substrate provides catalytic nucleation sites for nucleation and growth of stable crystalline phases during constrained solidification. However, high cooling rates associated with laser surface cladding resulted in highly refined microstructure in the coatings with improved hardness and wear properties.

Limited efforts have been made to eliminate the dilution effects by using the substrate of glass forming composition such that subsequent laser surface melting/resolidification causes surface amorphization. However, this limits the range of substrates that can be used for laser surface cladding. In general, the success in retaining fully amorphous structure in coatings deposited using laser processing and thermal spraying has been limited.

Recently, Spark Plasma Sintering (SPS) has attracted significant interest for the fabrication of bulk nanostructured and amorphous materials, which are otherwise difficult to process through other conventional sintering techniques like hot pressing (HP) and hot isostatic pressing (HIP). By combining the effects of uniaxial pressure and pulsed direct current, the process offers enormous possibilities of sintering these materials at significantly lower temperatures and shorter sintering times, e.g., less than an hour, compared to conventional hot sintering. While most of these investigations dealt with spark plasma sintering of bulk nanostructured materials, very limited efforts have been directed towards fabricating nanostructured or amorphous coatings.

Recently, researchers have reported fabrication of oxidation resistant aluminized MCrAlY (where M═Co, Ni, or Co/Ni) coatings on nickel superalloy substrate using spark plasma sintering. The coatings exhibited porosity-free homogeneous microstructure with good adherence and uniform inter-diffusion layer between the substrate and the coating. Fabrication of oxidation resistant Fe₃Al coating on austenitic stainless steel using spark plasma sintering has also been reported. Spark plasma sintering has also been used for post-spray processing of thermally-sprayed coatings. Significant improvements in the densities of thermally sprayed ZrO₂—MgO and WC—Co coatings have been reported using SPS as post-spray treatment. While researchers are extending the capabilities of the SPS process for the fabrication of novel compositions and microstructures, major efforts are being undertaken by the machine manufacturers to increase the size of the sintered samples up to 350 mm in diameter. With these developments, spark plasma sintering is expected to play an important role in the surface engineering of materials.

### SUMMARY OF THE INVENTION

In the present investigation, we explore the possibility of fabricating wear resistant amorphous coatings on aluminum alloy substrate using spark plasma sintering. Detailed analysis of the development of microstructure and the improvement in mechanical properties (hardness and wear resistance) for the amorphous coatings is presented.

Spark Plasma Sintering (SPS) is used to produce thick (˜400 μm) amorphous coatings of Fe₄₈Cr₁₅Mo₁₄Y₂C₁₅B₆ alloy composition on aluminum substrates. The coatings were fabricated using uniaxial pressure of 50 MPa over a range of temperatures (550-590° C.) below crystallization temperature (˜631° C.) of this glassy alloy. Under the investigated SPS processing parameters, the infiltration of the aluminum substrate material in the overlaid amorphous powder was observed resulting in composite amorphous coating. Detailed investigations on evolution of phases, microstructure, and interface characteristics in the amorphous coatings are presented. The amorphous coatings exhibited high surface hardness (˜880-1007 HV) and superior wear resistance (˜75-80% decrease in weight loss) compared to substrate material. The wear mechanisms were dominated by ploughing of soft aluminum phase in the interparticle regions, dislodging of amorphous particles, and microcutting (abrasion) of amorphous regions of the coatings.

### BRIEF DESCRIPTION OF THE DRAWINGS

FIG. 1 is a schematic of the spark plasma sintering set up for fabricating amorphous coatings on aluminum alloys substrate.

FIG. 2(a) is a DSC scan and (b) XRD pattern from the starting amorphous alloy powder of composition Fe₄₈Cr₁₅Mo₁₅₄Y₂C₁₅B₆ used for fabrication of amorphous coatings using SPS. The vertical arrows in FIG. 2 (a) indicate the characteristic transition temperatures of amorphous alloy.

FIG. 3 is SEM micrographs showing: (a) typical low magnification cross section of spark plasma sintered amorphous coating prepared at 590° C., and (b-d) high magnification interfacial regions of the amorphous coatings prepared at 560° C., 575° C., and 590° C. respectively.

FIG. 4 is XRD patterns from spark plasma sintered amorphous coatings fabricated with processing temperatures of a) 560° C., b) 575° C., and c) 590° C.

FIG. 5 is an EDS elemental map showing distribution of aluminum and iron in surface of amorphous coatings prepared at 560° C.

FIG. 6 is an EDS elemental map showing distribution of aluminum and iron in cross section of amorphous coatings prepared at 560° C.

FIG. 7 is an EDS line scans and corresponding elemental distributions across the interfaces for spark plasma sintered amorphous coatings processed at (a-b) 575° C. and (c-d) 590° C.

FIG. 8 is microhardness profiles along the thicknesses of spark plasma sintered amorphous coatings prepared with processing temperatures of 560° C., 575° C., and 590° C. The inset shows the SEM micrographs of the microhardness indentations in the interfacial regions of coating prepared at 560° C.

FIG. 9 is a graphical representation of a variation of coefficient of friction with sliding distance during wear testing of aluminum substrate and spark plasma sintered amorphous coatings prepared with processing temperatures of 560° C., 575° C., and 590° C.

FIG. 10 is a graphical representation of a variation of cumulative weight loss with sliding distance during wear testing of aluminum substrate and spark plasma sintered amorphous coatings prepared with processing temperatures of 560° C., 575° C., and 590° C.

FIG. 11 is a typical SEM micrograph and corresponding EDS map showing elemental distribution of aluminum on the worn surfaces of the amorphous coating. The regions enclosed by dark lines (marked A) and dotted lines (marked B) indicate amorphous-rich and aluminum-rich areas on the worn surface respectively.

FIG. 12 is a typical secondary and backscattered SEM images from worn surfaces of amorphous coatings showing (a) early and (b) later stages of wear process. The dark regions in the backscattered SEM images correspond to aluminum-rich areas on the worn surfaces.

### DETAILED DESCRIPTION OF THE PREFERRED EMBODIMENTS

In the present investigation, a starting amorphous powder of nominal composition Fe₄₈Cr₁₅Mo₁₄Y₂C₁₅B₆ was used for fabrication of amorphous coatings using spark plasma sintering. The amorphous powder was prepared by melting a mixture of high purity, i.e., greater than 99.9 wt. % purity, elemental powders, e.g., Fe, Cr, Mo, Y, B, and C with nominal glass forming composition, followed by high pressure gas atomization. Differential scanning calorimetry (DSC) with a constant heating rate of 20° C./min. was used to determine the glass transition and crystallization temperature of the as-received amorphous alloy powder. Although Fe₄₈Cr₁₅Mo₁₄Y₂C₁₅B₆ is discussed herein as an example, other amorphous powders may also be used wherein the amorphous powders have a crystallization temperature of approximately 600° C. and above. Examples include Fe₅₀Cr₁₅Mo₁₄C₁₅B₆ and Fe₄₈Cr₁₅Mo₁₄C₁₅B₆Er₂.

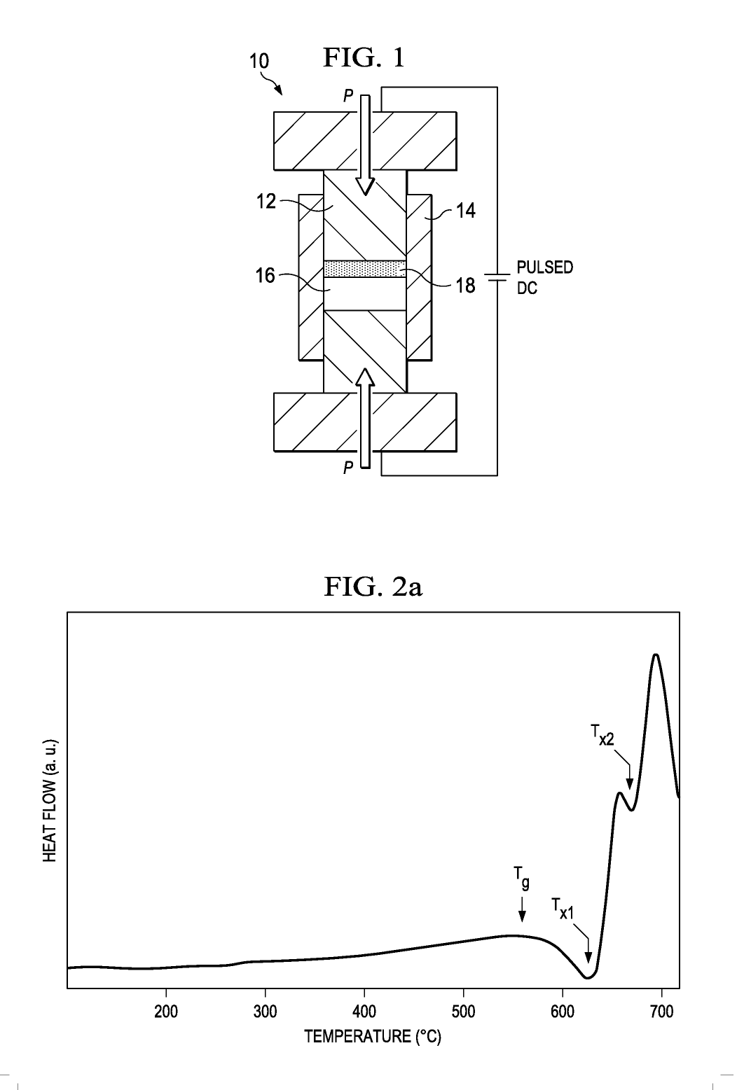

The substrates used in the present study were aluminum alloy discs of 20 mm diameter and 5 mm thickness. However, steel substrates are also acceptable for use. The substrate surfaces were well polished using 400 and 600 mesh abrasive papers before coating. Each substrate disc was then placed inside the graphite die and a measured quantity of amorphous powder was uniformly loaded on the substrate surface to form a ˜400 μm thick coating. Commercial spark plasma sintering equipment, i.e., Thermal Technology, Inc., Model 10-3, was used for forming an amorphous coating on the aluminum alloy substrate discs. A schematic of the SPS tooling arrangement used for fabricating amorphous coatings on aluminum alloy substrate is presented in FIG. 1. An example spark plasma sintering equipment 10 includes graphite punch 12 that is located in graphite punch 14. Substrate 16 is located within punch 14. Amorphous powder 18 is located on substrate 16. Uniaxial pressure is delivered via punch 14 and a pulsed DC current is passed through punch 14 for generating heat internally.

The SPS experiments were carried out under high vacuum under a pressure of 50 MPa at three different temperatures, i.e., 560° C., 575° C., and 590° C., which are well below the crystallization temperature of the given Fe-based amorphous alloy. It is believed that effective pressures range from approximately 30 MPa to 70 MPa. It is further believed that an effective temperature range for the Fe₄₈Cr₁₅Mo₁₄Y₂C₁₅B₆ powder is between 550° C. and 630° C. A typical processing cycle consisted of three steps: rapid heating cycle with a rate of 100° C./min, holding for 15 minutes at the processing temperature, and rapid cooling using nitrogen purging (cooling rate ˜150° C./minute). It is believed that rapid heating cycle rates of 50° C./min to 150° C./min would be effective. Additionally, it is believed that holding the sample at the processing temperature for approximately 5 to 20 minutes should be effective.

After SPS processing, the surfaces and cross sections of the amorphous coated aluminum substrates were prepared using conventional metallographic techniques for further microstructural analysis. The x-ray diffraction (XRD) analysis of the starting amorphous powder and coated surfaces was carried out using Philips Norelco x-ray diffractometer operating with Cu Kα (λ=1.54178 Å) radiation at 45 kV and 40 mA. The diffraction angle was varied between 30° and 70° 2θ at a step increment of 0.02° 2θ with a count time of 1 seconds. A microhardness tester (Buehler ®) was used for measuring hardness by performing indentations at a load of 2.94 N and holding time of 10 seconds. The microhardness was measured on the coating surface and also along the cross section. Around ten microhardness readings were taken at each location and an average value was reported. The wear tests were performed on the substrate and amorphous coated samples using a ball-on-disc tribometer (Nanovea®, Irvin, Calif.) at a load of 4 N and 136.3 rpm disc rotation. A 3 mm diameter aluminum oxide (Al₂O₃) ball was used as a counter body to create a wear track of 6 mm diameter on the sample surface. The weight loss was recorded as a function of linear sliding distance. The sample surfaces before and after wear were analyzed using a scanning electron microscope (SEM) equipped with energy dispersive spectroscopy (EDS) detector. Both topographic and back scattered images were used for analysis. The roughness of the samples before and after wear test was measured using surface roughness tester (Model TR200, Micro Photonics, Allentown, Pa.).

### 3. Results and Discussion:

### 3.1 Microstructure:

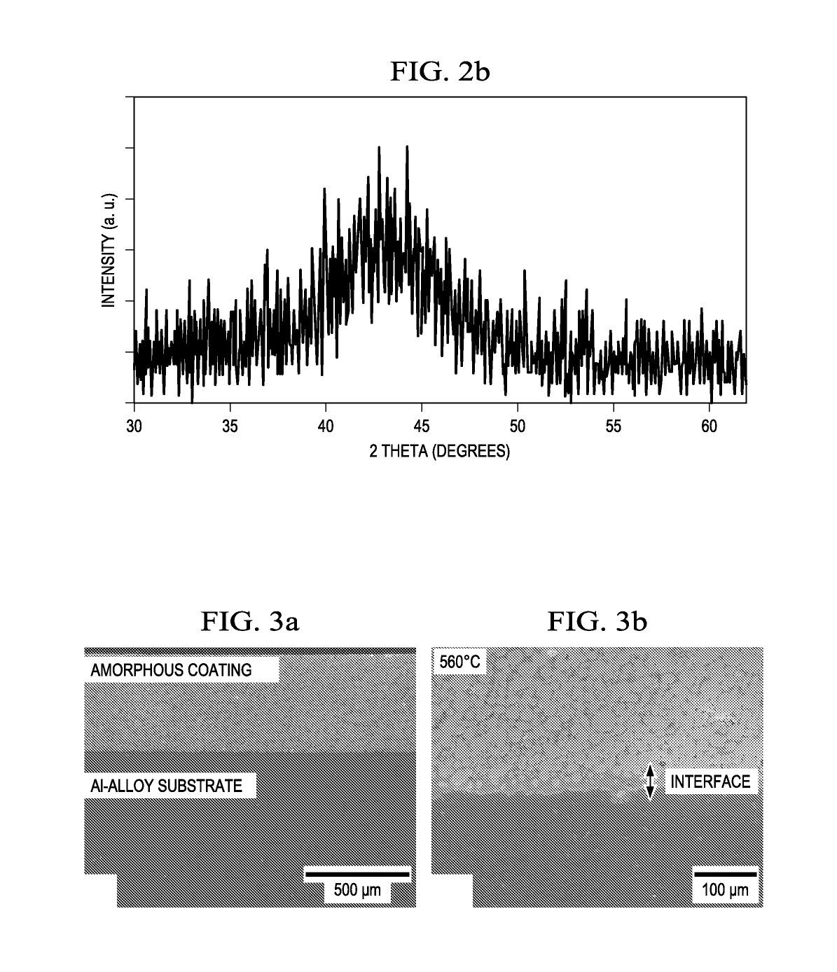

FIG. 2 presents the DSC scan and XRD pattern of the gas atomized Fe₄₈Cr₁₅Mo₁₄Y₂C₁₅B₆ powder. The powder exhibited a distinct glass transition temperature (Tg) at 575° C. followed by double exothermic crystallization (Tx1 and Tx2) peaks above 600° C. (FIG. 2a). The XRD pattern of the starting powder exhibited a characteristic broad peak with diffused intensity (FIG. 2b). These results confirmed that the starting alloy powder was glassy, i.e., amorphous, in nature and hence suitable for the proposed objective of developing amorphous coating on aluminum substrate by spark plasma sintering (SPS).

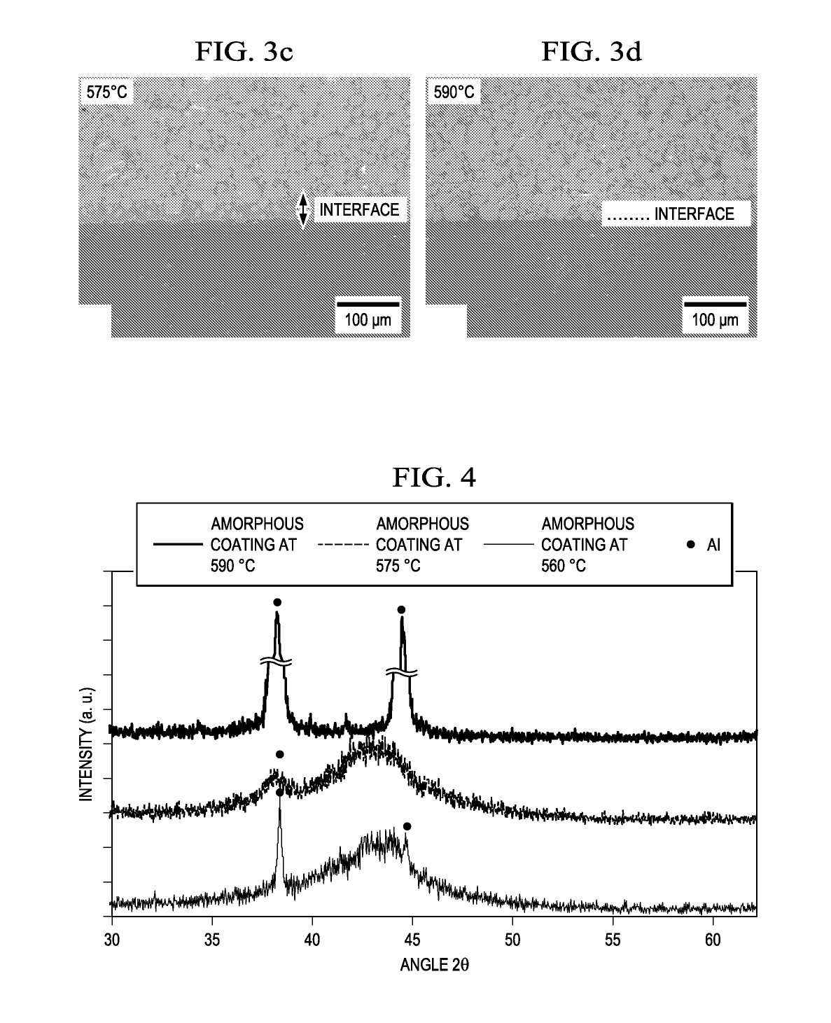

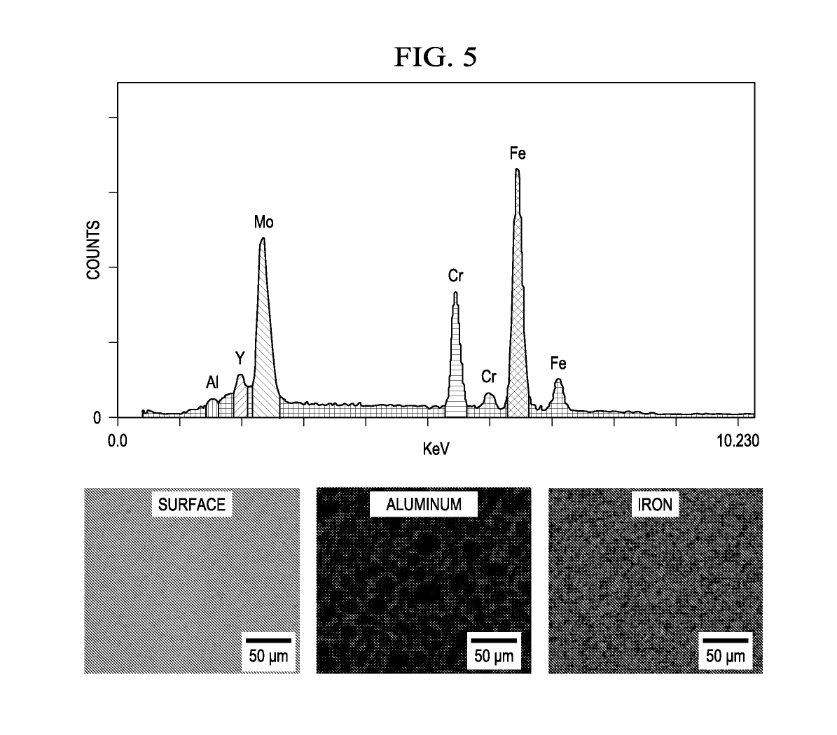

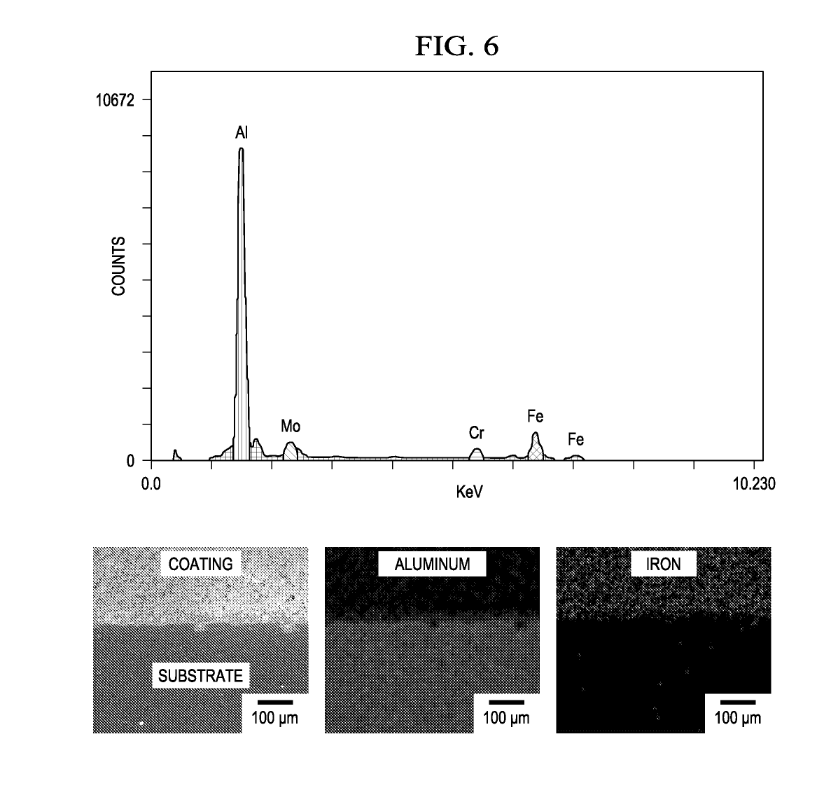

The typical microstructures of the cross section of the amorphous coatings prepared by spark plasma sintering are presented in FIG. 3. The figure indicates that the coatings prepared at various processing temperatures, i.e., 560° C. (FIG. 3b), 575° C. (FIGS. 3c), and 590° C. (FIGS. 3a and 3d), are fully dense and exhibit very good bonding with the underlying aluminum substrates, as indicated by the absence of porosities at the interface. The average thickness of the coatings is around 400 μm. In all the cases, the substrate aluminum alloy infiltrated into overlaid amorphous powder during SPS processing resulting in the formation of composite coating. The image analysis of the cross sections of the coatings indicated that almost 25% of the particles in the coating processed at 575° C. are bigger than 20 μm (˜20-50 μm range). We believe that the larger percentage of bigger particles (as large as 50 μm) in the coating processed at 575° C. is due to handling and processing of powder prior to sintering. The x-ray diffraction (XRD) patterns from the surfaces of the coatings are presented in FIG. 4. The XRD patterns shows broad peak corresponding to Fe-based amorphous material and superimposed crystalline peaks corresponding to infiltrated aluminum. The crystalline peaks in the XRD pattern of coatings prepared at 590° C. are strongest in intensity indicating that aluminum is a major phase at the surface of coatings. It seems that the substrate aluminum infiltrated across the full thickness of the amorphous powder layer and reached the surface of the coatings indicating highest degree of aluminum infiltration at this temperature. At lower temperatures (560° C. and 575° C.), the intensity of the crystalline peaks is relatively smaller indicating relatively lesser degree of infiltration of substrate aluminum at the surface of the coatings. Furthermore, the aluminum peaks in the XRD pattern for the coatings processed at 575° C. are not as sharp as they are in the XRD pattern for the coating prepared at 560° C. (lower temperature). The coatings prepared at 575° C. showed relatively bigger particles (10-50 μm) compared to coating prepared at 560° C. These bigger particles seem to retard the aluminum infiltration effects resulting in smaller relative proportion of aluminum at the surface of the coatings. The absence of sharp peak in the coating synthesized at 575° C. seems to be due to this smaller relative proportion of aluminum at the surface of the coatings. Note that the SPS processing of all coatings was carried out for the same time, i.e., 15 minutes. FIGS. 5 and 6 present the distribution of iron, which is a major element in the coating, and aluminum, which is a major element in the substrate, at the surface and cross section of the coatings prepared at 560° C. The figures clearly indicate the preferential distribution of aluminum between amorphous particles both at the surface and across the cross section of the coatings.

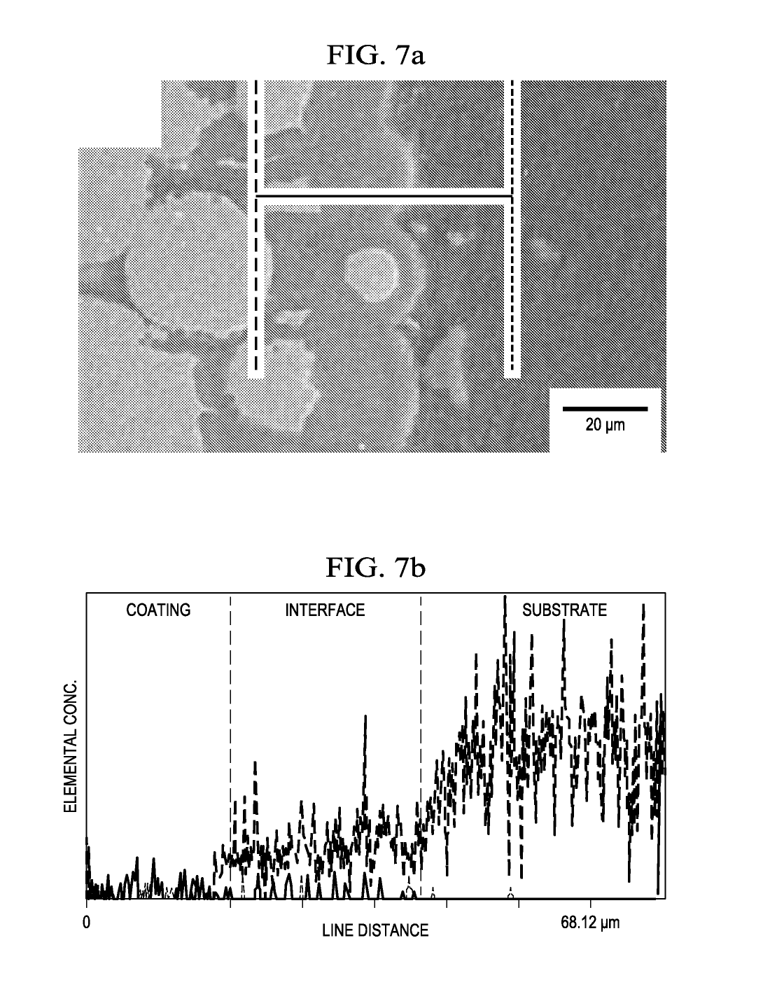

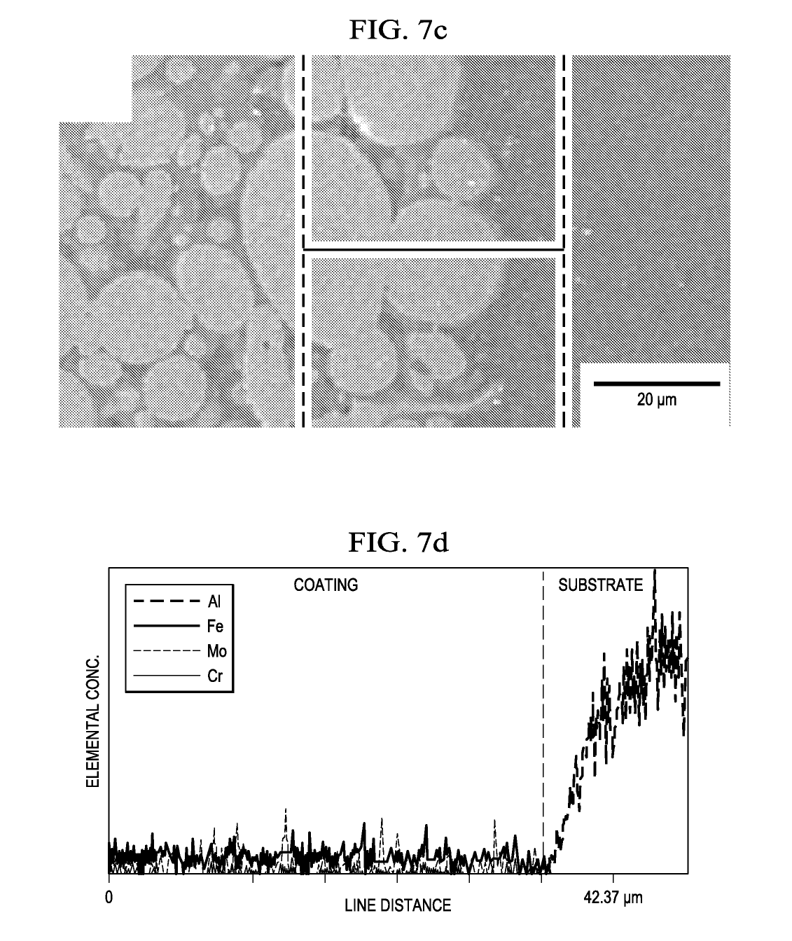

A careful look at the interfaces of the coatings showed interesting features (FIG. 3). The coatings prepared at lower temperatures (560° C. and 575° C.) show a distinct interdiffusion layer about 25 μm thick along the interface. The smaller amorphous particles distributed within the interdiffusion layer can be easily seen. Surprisingly, the coatings prepared at higher temperature (590° C.) do not show distinct interdiffusion layer at the interface. However, individual large particles near the interface show a very thin (˜1-2 μm) reaction layer on the particle surface as indicated by lighter contrast (FIG. 7). To analyze the composition of this reaction layer, significant efforts were made to map the elemental distribution across the cross-sections of the coatings. The elemental distribution along the line across the coating/substrate interface is also presented in FIG. 7. The figure clearly indicates that the interdiffusion layer at the interface in coatings prepared at low temperature, e.g., 575° C., consists of aluminum element. It seems that the amorphous particles at the interface partially reacted with the aluminum substrate forming the continuous interdiffusion layer. FIG. 7 also indicates a sharp change in the elemental aluminum content across the interface indicating absence of interdiffusion layer in coatings prepared at 590° C. The absence of distinct interdiffusion layer at the interface in coatings prepared at higher temperature, e.g., 590° C., is contrary to the common intuition that reaction rate increases with temperature. While the inter-diffusion at the interface is expected to be higher at higher temperature, e.g., 590° C., the enhanced plastic flow of aluminum substrate (due to higher temperature) under applied pressure is expected to cause continuous infiltration of aluminum into the overlaid amorphous powder. This dynamics of the plastic flow of aluminum at the amorphous powder surface seems to prevent the build-up of inter-diffusion layer resulting in sharp coating/substrate interface at higher temperature, e.g., 590° C. The observation of aluminum as a major phase at the surface of the coatings prepared at 590° C. is indicative of this enhanced infiltration effects as indicated by XRD analysis.

### 3.2 Microhardness:

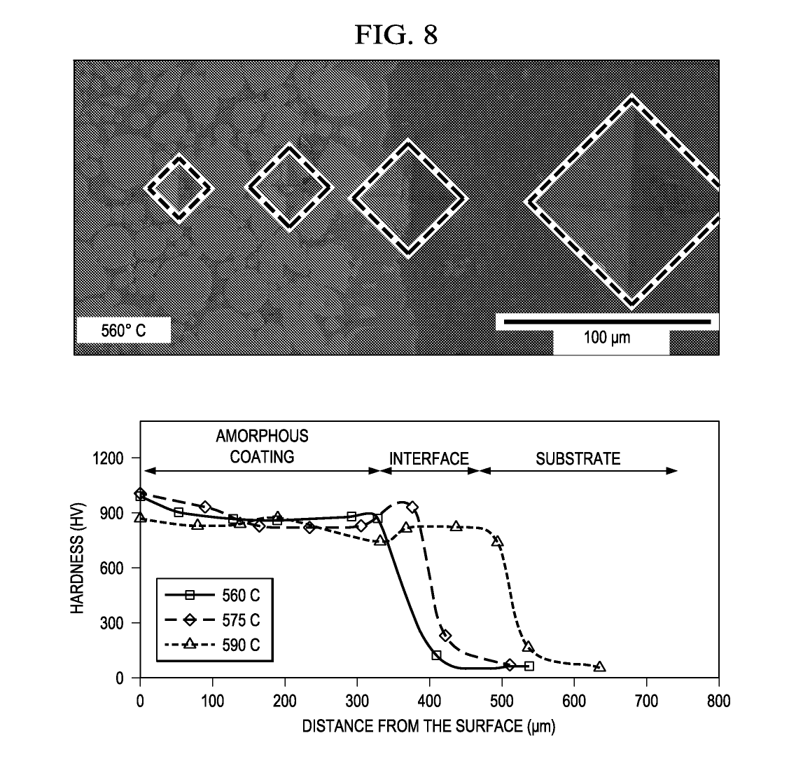

FIG. 8 presents the microhardness distribution along the depth of amorphous coatings prepared at various temperatures. The average hardness of the coatings prepared at 560° C., 575° C., and 590° C. were 990, 1007, and 880 HV respectively. The higher surface hardness, i.e., ˜1000 HV, of the coatings prepared at lower temperatures, e.g., 560° C. and 575° C., seems to be primarily due to presence of larger fraction of amorphous phase at the surface. The relatively lower surface hardness, i.e., 880 HV, of the coatings prepared at higher temperature, e.g., 590° C., is primarily due to presence of larger fraction of soft aluminum phase in the coating due to these enhanced infiltration effects. The high microhardness, i.e., 800-1000 HV, was retained along the 400 μm thickness of amorphous coatings followed by steep decrease at the interface region towards substrate. This trend is clearly indicated by the variation of indentation size across the interface (inset of FIG. 8). In our previous investigation, we observed that the microhardness of SPS sintered fully amorphous/partially crystallized amorphous alloys was in the range of 1200-1350 HV. The relatively lower hardness, i.e., 880-1007 HV, of the amorphous coatings in the present investigation is primarily due to infiltration of aluminum substrate material in the overlaid amorphous powder bed. The coatings thus exhibit composite amorphous-crystalline microstructure, the crystalline phase being the infiltrated aluminum substrate material. However, no devitrification of the amorphous powder was observed. The surface hardness of the amorphous coatings is almost 10 times the hardness of the substrate aluminum material.

### 3.3 Friction and Wear:

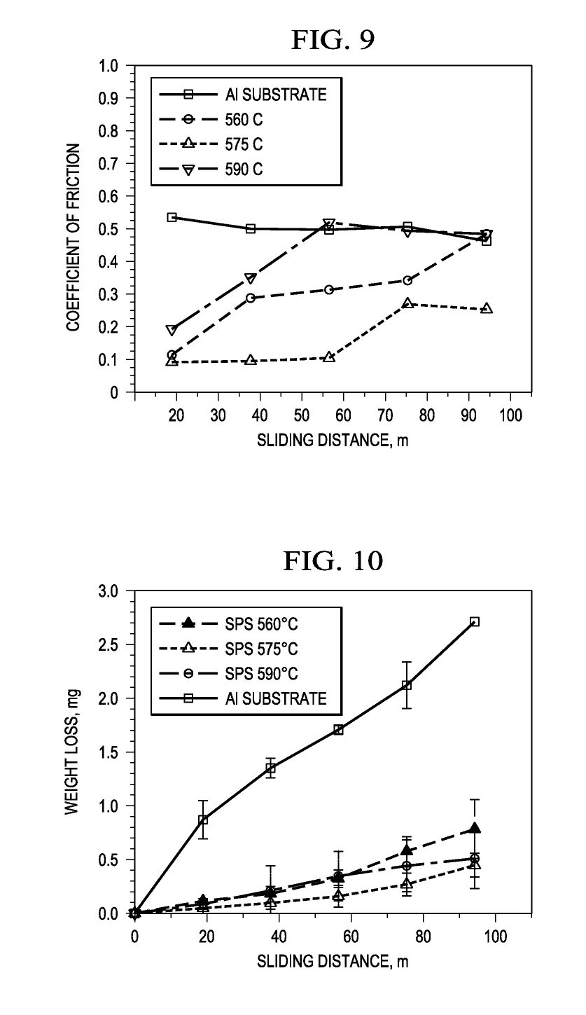

FIG. 9 presents the variation of friction coefficient as a function of sliding distance for the substrate and the amorphous coatings prepared at various temperatures. The aluminum alloy substrate exhibited uniform friction coefficient in the range of 0.45-0.55 indicating stable sliding during wear test. However, amorphous coating exhibited distinct regimes of wear process characterized by low friction coefficient in the initial stage and high friction coefficient in the later stages separated by a transition region. The friction coefficient corresponding to 20 m of sliding distance is in the range of 0.1-0.2. The lower values of friction coefficient in the initial stages of wear test can be attributed to low surface roughness of the coatings. The initial measured roughness of all the coatings was in the range of 0.065-0.075 μm. The post-wear surface roughness for coatings processed at 560° C., 575° C., and 590° C. were 13.9, 21.0, and 16.3 μm respectively. Except for the coating prepared at 575° C., the friction coefficient quickly increases and stabilizes between 0.3-0.5 at sliding distance longer than 50 m.

Similar distinct regimes of wear processes have been observed for various Zr-based amorphous alloys (as-cast, deformed, and creep-tested). Jiang et. al. reported that these regimes corresponds to running-in, transition, and steady state. The steady state friction coefficient of the as-cast Zr-based amorphous alloy reported by Jiang et. al. was around 0.8. Abrasive wear is often considered as a dominating micro-mechanism of wear in amorphous alloys. The lower steady state friction coefficients, i.e., 0.3-0.5, reported in the present investigation seems to be due to presence of soft aluminum phase in the amorphous coatings due to substrate infiltration. This soft aluminum phase between the amorphous particles wears out faster resulting in softer wear debris that provides lubricating effects.

The wear response of the amorphous coatings in ball-on-disc configuration was also studied by monitoring weight loss with siding distance during test (FIG. 10). The weight loss was highest at all sliding distances for the aluminum substrate compared to amorphous coatings prepared at all temperatures, i.e., 560° C., 575° C., 590° C. The amorphous coatings exhibited superior wear resistance compared to substrate aluminum alloy as indicated by significantly lesser weight loss for amorphous coatings. The decrease in weight loss of aluminum substrate with amorphous coatings is more than 75-80%. The coating prepared at 575° C. exhibited highest wear resistance. This coating also exhibited highest surface hardness, i.e., 1007 HV. Considering the significant extent of standard deviation, i.e., length of error bars, of data points in FIG. 10, there is not significant effect of SPS temperature on the wear weight loss for amorphous coatings.

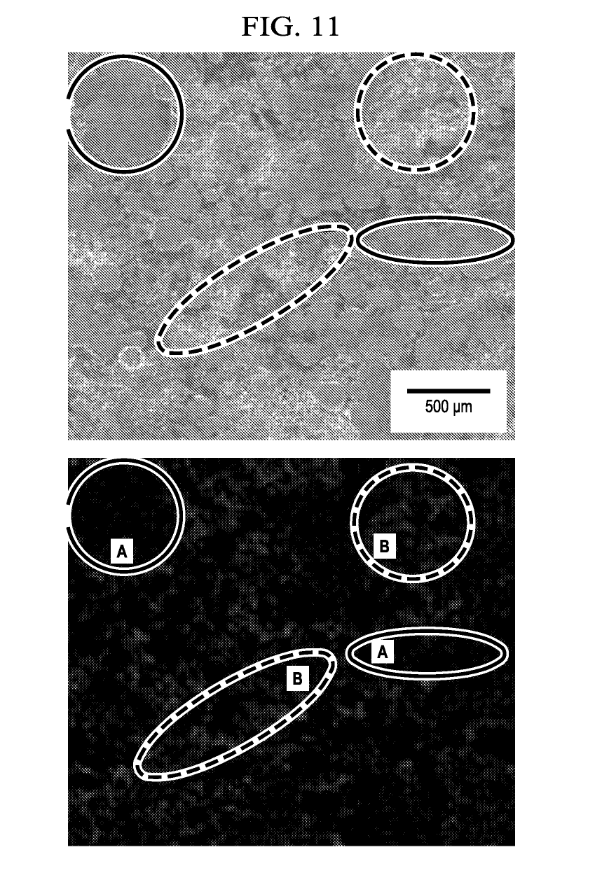

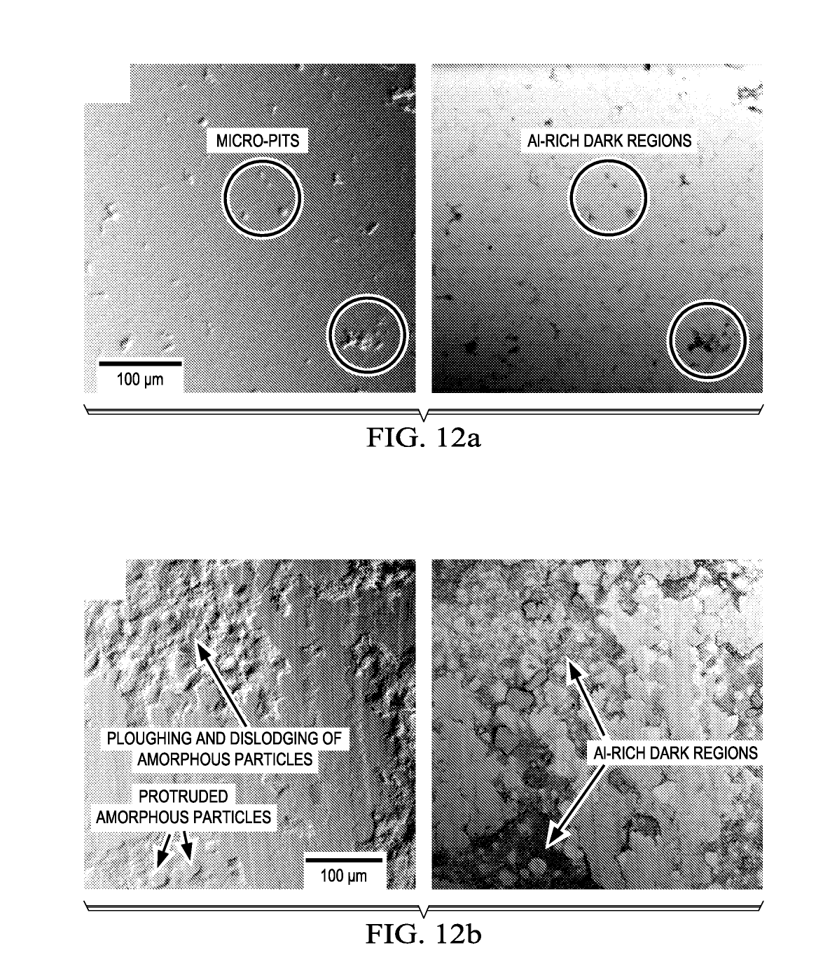

The worn surfaces of the amorphous coatings were examined by SEM. FIG. 11 presents a typical micrograph of the worn surface of the amorphous coating. Two regions can be easily identified in the worn surfaces: amorphous particle regions (marked “A”) and aluminum-rich regions (marked “B”). It seems that the wear process initiates by ploughing the soft aluminum phase present between the amorphous particles resulting in formation of micro-pits (FIG. 12a). The backscattered SEM image clearly indicates dark regions corresponding to aluminum-rich phase due to compositional contrast between the regions of micropits and the surrounding unworn surface. The continuous wear eventually causes dislodging or pull-out of some amorphous particles. The underlying aluminum-rich regions, after the amorphous particles are dislodged, appear as dark regions (FIG. 12b). Furthermore, some amorphous particles remain protruded out on the worn surface (no dislodging) and show scratches and micro-cutting marks indicative of abrasive wear. Thus, the wear mechanisms of amorphous coatings prepared by SPS are dominated by particle pull-outs and abrasive wear of amorphous particles/regions.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A method fabricating an amorphous coating on a substrate comprising the steps of:
locating an amorphous alloy powder onto a metallic substrate;
applying a pressure to said powder and substrate;
subjecting said powder and substrate to a processing temperature below a crystallization temperature of said powder;
spark plasma sintering said powder and said substrate for infiltrating said substrate into said powder for resulting in a composite amorphous coating.

2. The method according to claim 1 wherein:
said amorphous alloy powder has a crystallization temperature of approximately 600° C. or above.

3. The method according to claim 2 wherein:
said powder is comprised of Fe₄₈Cr₁₅Mo₁₄Y₂C₁₅B₆.

4. The method according to claim 2 wherein:
said powder is comprised of Fe₅₀Cr₁₅Mo₁₄C₁₅B₆.

5. The method according to claim 2 wherein:
said powder is comprised of Fe₄₈Cr₁₅Mo₁₄C₁₅B₆Er₂.

6. The method according to claim 1 wherein:
said metallic substrate comprises aluminum.

7. The method according to claim 1 wherein:
said metallic substrate comprises steel.

8. The method according to claim 1 further comprising the steps of:
rapidly heating said powder and said substrate at a rate between approximately 50° C./min to 150° C./min;
holding said powder and said substrate for between approximately 10-20 minutes at said processing temperature; and
rapidly cooling said powder and said substrate.

9. The method according to claim 8 wherein:
said powder and said substrate are heated at a rate of approximately 100° C./min.

10. The method according to claim 8 wherein:
said step of holding is conducted for approximately 15 minutes.

11. The method according to claim 8 wherein:
said step of rapidly cooling comprises cooling said powder and said substrate at a cooling rate of approximately ˜150° C./minute.

12. The method according to claim 1 wherein:
said step of applying a pressure to said powder and substrate comprises applying between approximately 30-70 Mpa of pressure.

13. The method according to claim 12 wherein:
said step of applying a pressure to said powder and substrate comprises applying approximately 50 Mpa of pressure.

14. The method according to claim 1 wherein:
said step of subjecting said powder and said substrate to a processing temperature comprising subjecting said powder to a processing temperature of between approximately 550° C. and 630° C.

15. The method according to claim 1 wherein:
said composite amorphous coating has a hardness between approximately 880 and 1007 HV.

16. The method according to claim 1 wherein:
said composite amorphous coating has an average thickness of approximately 400 μm.

17. The method according to claim 1 wherein:
no interdiffusion layer is present between said substrate and said composite amorphous coating.

18. A coated substrate comprising:
a metallic substrate;
an amorphous coating joined to said substrate;
wherein no interdiffusion layer exists between said substrate and said amorphous coating.

19. The coated substrate according to claim 18 wherein:
said metallic substrate comprises aluminum.

20. The coated substrate according to claim 18 wherein:
said metallic substrate comprises steel.

21. The coated substrate according to claim 18 wherein:
said amorphous coating is comprised of Fe₄₈Cr₁₅Mo₁₄Y₂C₁₅B₆.

22. The coated substrate according to claim 18 wherein:
said amorphous coating is comprised of Fe₅₀Cr₁₅Mo₁₄C₁₅B₆.

23. The coated substrate according to claim 18 wherein:
said amorphous coating is comprised of Fe₄₈Cr₁₅Mo₁₄C₁₅B₆Er₂.

24. The coated substrate according to claim 18 wherein:
said amorphous coating has a hardness of between approximately 800 and 1007 HV.

25. The coated substrate according to claim 18 wherein:
said amorphous coating has a thickness of approximately 400 μm.
